(19) United States
(12) Patent Application Publication
(10) Pub. No.: US 2006/0167820 A1
(43) Pub. Date: Jul. 27, 2006

(54) Non-authentication access management system for affiliated websites linked with advertisement

(76) Inventors: Hee-Chun Jeong, Kyeonggi-Do (KR); Bong-Chun Jeong, Kyeonggi-Do (KR)

Correspondence Address: CANTOR COLBURN, LLP, 55 GRIFFIN ROAD SOUTH, BLOOMFIELD, CT, 06002, US

(21) Appl. No.: 10/536,249

(22) PCT Filed: Nov. 27, 2003
(86) PCT No.: PCT/KR03/02589

§ 371 Date: May 20, 2005

(30) Foreign Application Priority Data
Dec. 9, 2002 (KR) 10-2002-0077824

(51) Int. Cl. G06Q 99/00; H04L 9/00; H04K 1/00

(52) U.S. Cl. 705/67

(57) ABSTRACT

A system for managing non-authentication-based access to at least one affiliated Web site linked with an advertisement is disclosed. A semi-compulsory advertising technique is used to compel the user to view a customized advertisement associated with the affiliated Web site and allow him/her to gain the non-authentication-based access to the affiliated Web site, which requires authentication, in reward for viewing the advertisement. Therefore, the user is able to use various pay sites free of charge for a limited period of time without member registration.

### TECHNICAL FIELD

The present invention relates to a system for managing non-authentication-based access to affiliated Web sites linked with an advertisement, and more particularly to an advertising technique using authentication numbers printed on offline cards such as business cards.

### BACKGROUND ART

Up to now, many advertising techniques have been used online/offline. Newspaper advertisements, which are representative offline advertisements, and Internet banner advertisements, which are representative online advertisements, are advertising techniques most frequently met with by people in modern society.

However, advertising effects of such a conventional offline advertisement through mass distribution or such a conventional banner advertisement through a famous Web site are actually slight as compared with a heavy advertising outlay taken for the advertisement.

In this connection, this inventor has researched and developed a system for managing non-authentication-based access to affiliated Web sites linked with an advertisement, wherein a semi-compulsory advertising technique is used to allow a user to gain the non-authentication-based access to the Web sites, which require authentication, in reward for viewing the advertisement.

### DISCLOSURE OF THE INVENTION

Therefore, the present invention has been made in view of the above problems, and it is an object of the present invention to provide a system for managing non-authentication-based access to affiliated Web sites linked with an advertisement, wherein a semi-compulsory advertising technique is used to allow a user to gain the non-authentication-based access to the affiliated Web sites, which require authentication, in reward for viewing the advertisement.

It is another object of the present invention to provide a system for managing non-authentication-based access to affiliated Web sites linked with an advertisement, wherein a user is semi-compelled to view customized advertisements associated respectively with the affiliated Web sites.

In accordance with the present invention, the above and other objects can be accomplished by the provision of a system for managing non-authentication-based access to at least one affiliated Web site linked with an advertisement, comprising: an authentication number database for storing authentication numbers for the non-authentication-based access to the affiliated Web site within a limited period of time; an authentication number receiver for providing a screen interface for authentication number input to a user computer and receiving an authentication number for the time-limited, non-authentication-based access inputted from the user computer; a user authentication processor for searching the authentication number database for the same authentication number as that received by the authentication number receiver to determine whether the same authentication number is present in the database, and performing a user authentication process based on the determination result; an advertisement processor for, if a user of the user computer is authenticated by the user authentication processor, sending information about the advertisement to the user computer to compulsorily run the advertisement therein; and an access processor for processing the time-limited, non-authentication-based access from the user computer to the affiliated Web site in response to advertisement completion information from the advertisement processor.

Preferably, the advertisement processor may send information about a specific advertisement linked to the authentication number inputted from the user computer to the user computer to compulsorily run the specific advertisement therein.

Preferably, the access processor may process the time-limited, non-authentication-based access from the user computer in such a manner that it induces the access from the user computer to a back door site requiring no ID and password input, provided from the affiliated Web site.

Alternatively, the access processor may process the time-limited, non-authentication-based access from the user computer in such a manner that it sends time-limited, non-authentication-based access request information containing an Internet protocol (IP) address of the user computer to the affiliated Web site so that the Web site grants the access from the user computer with the IP address.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram schematically showing the configuration of a network to which the present invention is applied;

FIG. 2 is a block diagram showing the configuration of a system for managing non-authentication-based access to affiliated Web sites linked with an advertisement according to a preferred embodiment of the present invention; and

FIG. 3 is a flow chart illustrating the operation of the non-authentication-based access management system of FIG. 2.

### BEST MODE FOR CARRYING OUT THE INVENTION

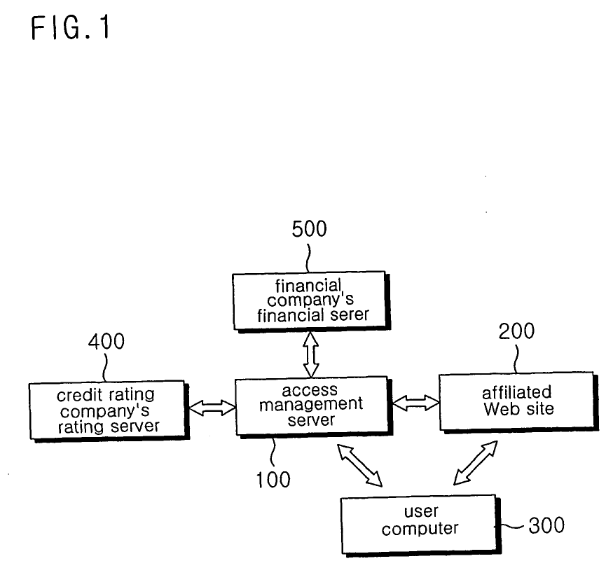

With reference to FIG. 1, there is schematically shown in block form the configuration of a network to which the present invention is applied. As shown in this drawing, the network comprises an access management server 100 including a system for managing non-authentication-based access to at least one affiliated Web site 200 linked with an advertisement according to the present invention, which is installed and executed in the server 100 in the form of software. The affiliated Web site 200 is provided in the form of a remote server. The network further comprises at least one user computer 300 for gaining the non-authentication-based access to the affiliated Web site 200 under control of the access management server 100, a credit rating company's rating server 400 for performing an adult authentication process in response to adult authentication request information inputted and sent from the user computer 300 to the access management server 100, and a financial company's financial server 500 for performing a settlement process based on payment information for charging of an authentication number from the user computer 300.

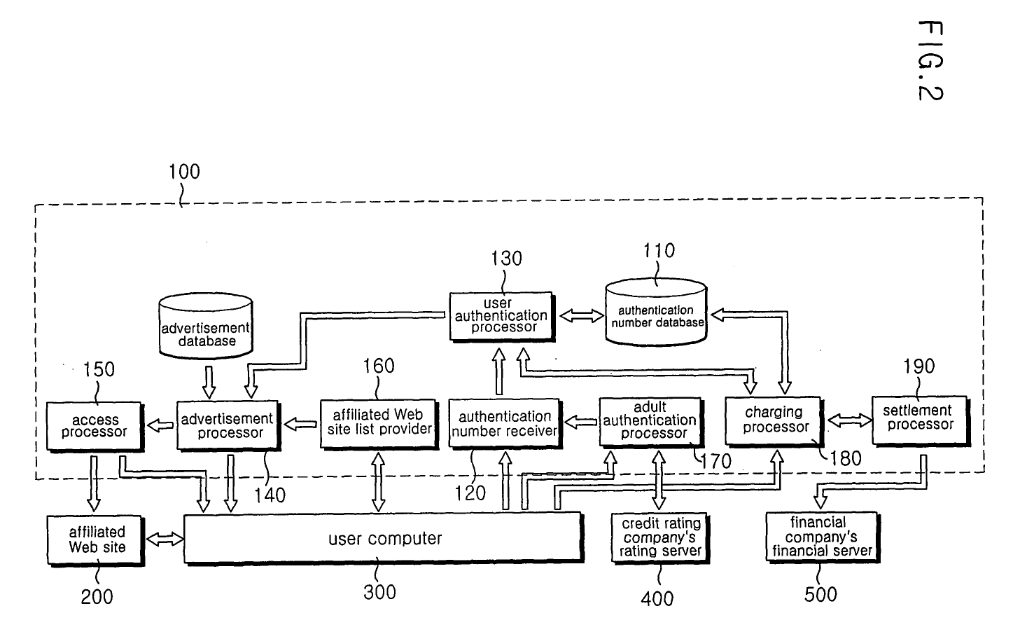

FIG. 2 is a block diagram showing the configuration of the non-authentication-based access management system according to a preferred embodiment of the present invention.

As shown in FIG. 2, the non-authentication-based access management system according to the embodiment of the present invention comprises an authentication number database 110, an authentication number receiver 120, a user authentication processor 130, an advertisement processor 140, an access processor 150, an affiliated Web site list provider 160, an adult authentication processor 170, a charging processor 180, and a settlement processor 190.

The authentication number database 110 is adapted to store authentication numbers for the non-authentication-based access to the affiliated Web site 200 within a limited period of time.

The non-authentication-based access management system according to the present embodiment issues cards recorded respectively with authentication numbers for the time-limited, non-authentication-based access to the affiliated Web site 200, and stores the authentication numbers of the issued cards in the authentication number database 110.

In the present embodiment, the cards recorded with the respective authentication numbers for the time-limited, non-authentication-based access to the affiliated Web site 200 may be offline cards distributed offline to users, such as advertisement leaflets or business cards of various individuals or companies, or online electronic cards sent to user computers over the Internet.

The authentication number receiver 120 is adapted to provide a screen interface for authentication number input to the user computer 300 and receive an authentication number for the time-limited, non-authentication-based access inputted from the user computer 300.

A user of the user computer 300 acquires a card recorded with an authentication number online/offline, and makes a connection to the access management server 100, which executes the non-authentication-based access management system according to the present embodiment, over the network using the user computer 300. At this time, it is preferable that the user registers himself/herself as a member in the access management server 100 by inputting information containing his/her personal details to the server 100.

Then in the non-authentication-based access management system according to the present embodiment, the authentication number receiver 120 provides the screen interface for authentication number input to the user computer 300 and receives the authentication number for the time-limited, non-authentication-based access recorded on the acquired card, inputted through the user computer 300 by the user.

The user authentication processor 130 is adapted to search the authentication number database 110 for the same authentication number as that received by the authentication number receiver 120 to determine whether the same authentication number is present in the database 110, and perform a user authentication process based on the determination result.

In other words, since the authentication numbers of the issued cards are stored in the authentication number database 110, the user authentication processor 130 searches the database 110 for the same authentication number as that received by the authentication number receiver 120 to determine whether the same authentication number is present in the database 110, and authenticates the user if the same authentication number is present in the database 110. This technique for searching the database and performing the user authentication process based on the search result is well known in the art and a detailed description thereof will thus be omitted.

The advertisement processor 140 is adapted to, if the user is authenticated by the user authentication processor 130, send information about the advertisement to the user computer 300 to compulsorily run the advertisement therein.

That is, in the case where the user is authenticated by the user authentication processor 130, the advertisement processor 140 sends the advertisement information, which is stored in an advertisement database, to the user computer 300, so as to compulsorily run the advertisement through a Web browser of the user computer 300. At this time, it is preferable that the advertisement processor 140 controls the user computer 300 to stop the execution of all events therein, such as key input, etc., so as to prevent the user from shutting down the advertisement by force.

As an alternative, the advertisement processor 140 may send information about a specific advertisement linked to the authentication number to the user computer 300 to compulsorily run the specific advertisement therein.

That is, a specific advertisement linked to the authentication number recorded on the online/offline card acquired by the user, for example, an advertisement of a company which has requested the issuance of that card, may be compulsorily run in the user computer 300. To this end, the advertisement database may further store information about advertisements linked respectively to the authentication numbers stored in the authentication number database 110, so that the advertisement processor 140 can extract the information about the specific advertisement linked to the authentication number of the online/offline card acquired by the user from the advertisement database and send the extracted advertisement information to the user computer 300 to compulsorily run the specific advertisement therein.

The access processor 150 is adapted to process the time-limited, non-authentication-based access from the user computer 300 to the affiliated Web site 200 in response to advertisement completion information from the advertisement processor 140.

In other words, upon receiving the advertisement completion information from the advertisement processor 140, the access processor 150 allows the user to gain the time-limited, non-authentication-based access to the affiliated Web site 200 through the user computer 300 in reward for viewing the compulsorily run advertisement.

For example, the user may receive a business card recorded with an authentication number from a waiter of a night club and, after returning home, make a connection to a Web site, which executes the non-authentication-based access management system according to the present invention, over the Internet using his/her user computer. In this case, provided that the user inputs the authentication number recorded on the business card, he/she is forced to view a desired advertisement, for example, an advertisement of the night club, through the user computer. If the advertisement is completed, then the user is allowed to gain the time-limited, non-authentication-based access to an adult site for a predetermined period of time without separate authentication to enjoy adult contents. Provided that the user intends to use the adult site, not via the non-authentication-based access management system according to the present invention, under the condition that the adult site is a pay site, he/she has to input his/her personal information to the adult site to register himself/herself as a member thereof, and periodically pay a predetermined usage fee to the adult site. However, where the user uses the non-authentication-based access management system according to the present invention, he/she has the advantage of being able to use various pay sites free of charge for a limited period of time without member registration and separate authentication.

On the other hand, the access processor 150 can process the time-limited, non-authentication-based access from the user computer 300 in such a manner that it induces the access from the user computer 300 to a back door site requiring no ID and password input, provided from the affiliated Web site 200.

Alternatively, the access processor 150 may process the time-limited, non-authentication-based access from the user computer 300 in such a manner that it sends time-limited, non-authentication-based access request information containing an Internet protocol (IP) address of the user computer 300 to the affiliated Web site 200 so that the Web site 200 grants the access from the user computer 300 with the IP address.

Techniques related to the above-mentioned site access induction are well known in the art and a detailed description thereof will thus be omitted.

The affiliated Web site list provider 160 is adapted to provide a screen interface for affiliated Web site selection with link information regarding a plurality of affiliated Web sites to the user computer 300 and receive affiliated Web site selection information from the user computer 300.

That is, the affiliated Web site list provider 160 provides one screen picture with link information of a plurality of affiliated Web sites implemented in the form of banner bars to the user computer 300 before the advertisement processor 140 performs the advertisement process. If the user clicks on a specific one of the banner bars of the affiliated Web sites, the advertisement processor 140 sends information about an advertisement allocated to the specific banner bar to the user computer 300 to compulsorily run the advertisement therein. In this manner, the user can select a desired advertisement to be viewed.

The adult authentication processor 170 is adapted to provide a screen interface for adult authentication to the user computer 300, receive personal information of the user containing his/her name and resident registration number inputted from the user computer 300, request the rating server 400 of the credit rating company, which is an authorized credit information company, to identify the user with the personal information, receive the identification result from the rating server 400 and perform an adult authentication process based on the received identification result.

Provided that an advertisement to be compulsorily run or a Web site to be accessed under non-authentication is not available for minors, the adult authentication processor 170 provides a screen interface for adult authentication, for example, a screen picture for name/resident registration number input, to the user computer 300, receives the user's personal information containing his/her name and resident registration number inputted from the user computer 300 and requests the rating server 400 of the credit rating company, which is an authorized credit information company, to identify the user with the personal information. Then, the adult authentication processor 170 receives the identification result from the rating server 400 and performs an adult authentication process based on the received identification result. As a result, minors can be restrained from viewing adult advertisements or gaining the non-authentication-based access to adult sites.

The charging processor 180 is adapted to receive charging request information containing the authentication number for the time-limited, non-authentication-based access from the user computer 300, search the authentication number database 110 for the same authentication number as that contained in the received charging request information to determine whether the same authentication number is present in the database 110, authenticate the authentication number contained in the received charging request information if the same authentication number is present in the database 110, and charge the authenticated authentication number so that it can be reused.

The authentication number for the time-limited, non-authentication-based access to the affiliated Web site 200, recorded on the card acquired by the user, is a code enabling the user to gain the time-limited, non-authentication-based access to the affiliated Web site 200 for a predetermined period of time. If the predetermined period of time elapses, it is no longer possible for the user to gain the time-limited, non-authentication-based access to the affiliated Web site 200 using the recorded authentication number. In this connection, in the non-authentication-based access management system according to the present embodiment, the charging processor 180 provides a screen interface for authentication number charging to the user computer 300 in response to a request therefrom, receives charging request information containing the authentication number for the time-limited, non-authentication-based access from the user computer 300 and searches the authentication number database 110 for the same authentication number as that contained in the received charging request information to determine whether the same authentication number is present in the database 110. If the same authentication number is determined to be present in the authentication number database 110, the charging processor 180 authenticates the authentication number contained in the received charging request information and charges the authenticated authentication number. Therefore, the user can continuously use the non-authentication-based access service.

The settlement processor 190 is adapted to provide a screen interface for payment request associated with the authentication number charging to the user computer 300, and request the financial company's financial server 500 to perform a settlement process based on payment information inputted from the user computer 300.

In the present embodiment, the charging processor 180 may provide the authentication number charging service free of charge or with charge in association with a payment module for credit card payment, mobile phone payment or etc. In order to provide the authentication number charging service with charge, the settlement processor 190 provides a screen interface for payment request associated with the authentication number charging to the user computer 300, and requests the financial company's financial server 500 to perform a settlement process based on payment information inputted from the user computer 300. Techniques related to the above-mentioned payment module for credit card payment, mobile phone payment or etc. are well known in the art and a detailed description thereof will thus be omitted.

On the other hand, the non-authentication-based access management system according to the present invention may allow the user to gain the time-limited, non-authentication-based access to all of a plurality of affiliated Web sites with one authentication number.

Therefore, in the non-authentication-based access management system according to the present invention, as described above, a semi-compulsory advertising technique is used to allow the user to gain the non-authentication-based access to at least one affiliated Web site, which requires authentication, in reward for viewing an advertisement. In addition, the user is semi-compelled to view customized advertisements associated respectively with a plurality of affiliated Web sites.

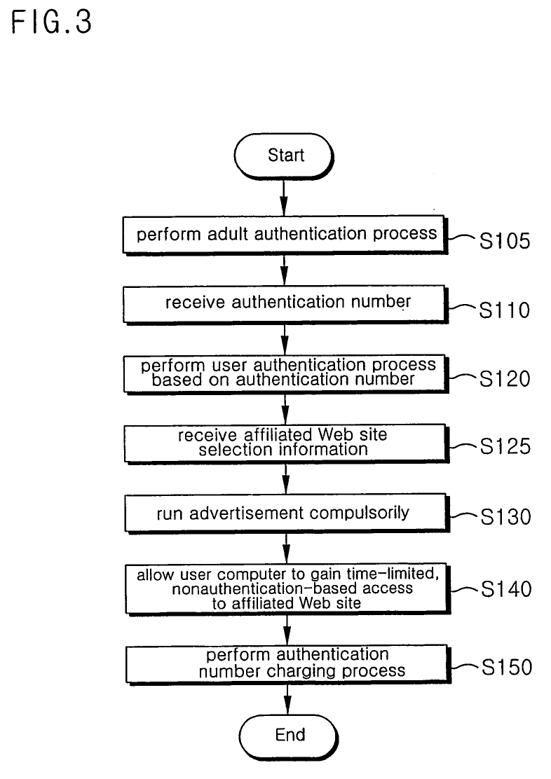

FIG. 3 is a flow chart illustrating the operation of the non-authentication-based access management system of FIG. 2.

A detailed description will hereinafter be given of the operation of the non-authentication-based access management system with the above-stated configuration according to the embodiment of the present invention with reference to FIG. 3.

First, at step S110, the authentication number receiver 120 receives an authentication number from the user computer 300 of the user with a card recorded with the authentication number.

At step S120, the user authentication processor 130 searches the authentication number database 110 for the same authentication number as that received by the authentication number receiver 120 to determine whether the same authentication number is present in the database 110, and performs a user authentication process based on the determination result.

If the user is authenticated by the user authentication processor 130, the advertisement processor 140 sends information about an advertisement to the user computer 300 to compulsorily run the advertisement therein at step S130. At this time, the advertisement processor 140 sends advertisement information linked to the authentication number to the user computer 300 so that the user can be semi-compelled to view a customized advertisement associated with the affiliated Web site 200.

At step S140, in response to advertisement completion information from the advertisement processor 140, the access processor 150 allows the user computer 300 to gain the time-limited, non-authentication-based access to the affiliated Web site 200.

Further provided between step S120 and step S130 may be step S125 at which the affiliated Web site list provider 160 provides a screen interface for affiliated Web site selection with link information regarding a plurality of affiliated Web sites to the user computer 300 and receives affiliated Web site selection information from the user computer 300, thereby enabling the user to select a desired affiliated Web site advertisement to be viewed.

Further provided before step S110 may be step S105 at which the adult authentication processor 170 receives personal information of the user containing his/her name and resident registration number inputted from the user computer 300, requests the rating server 400 of the credit rating company, which is an authorized credit information company, to identify the user with the personal information, receives the identification result from the rating server 400 and performs an adult authentication process based on the received identification result, thereby enabling minors to be restrained from viewing adult advertisements or gaining the non-authentication-based access to adult sites.

Further provided after step S140 may be step S150 at which the charging processor 180 receives charging request information containing the authentication number for the time-limited, non-authentication-based access from the user computer 300, searches the authentication number database 110 for the same authentication number as that contained in the received charging request information to determine whether the same authentication number is present in the database 110, authenticates the authentication number contained in the received charging request information if the same authentication number is present in the database 110, and charges the authenticated authentication number, thereby enabling the authentication number to be reused.

The above step S150 may include a settlement step of, by the settlement processor 190, providing a screen interface for payment request associated with the authentication number charging to the user computer 300, and requesting the financial company's financial server 500 to perform a settlement process based on payment information inputted from the user computer 300, thereby enabling the authentication number charging service to be provided with charge.

In the above manner, the non-authentication-based access management system according to the present invention can accomplish the above-presented objects.

### INDUSTRIAL APPLICABILITY

As apparent from the above description, according to the present invention, a semi-compulsory advertising technique is used to compel a user to view a customized advertisement associated with at least one affiliated Web site and allow him/her to gain non-authentication-based access to the affiliated Web site, which requires authentication, in reward for viewing the advertisement. Therefore, the user is able to use various pay sites free of charge for a limited period of time without member registration and separate authentication.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A system for managing non-authentication-based access to at least one affiliated Web site linked with an advertisement in an advertising system using authentication numbers printed on offline cards including business cards, comprising:
an authentication number database for storing authentication numbers for the non-authentication-based access to said affiliated Web site within a limited period of time;
an authentication number receiver for providing a screen interface for authentication number input to a user computer and receiving an authentication number for the time-limited, non-authentication-based access inputted from the user computer;
a user authentication processor for searching said authentication number database for the same authentication number as that received by said authentication number receiver to determine whether the same authentication number is present in said database, and performing a user authentication process based on the determination result;
an advertisement processor for, if a user of said user computer is authenticated by said user authentication processor, sending information about said advertisement to said user computer to compulsorily run said advertisement therein; and
an access processor for processing the time-limited, non-authentication-based access from said user computer to said affiliated Web site in response to advertisement completion information from said advertisement processor.

2. A system for managing non-authentication-based access to at least one affiliated Web site linked with an advertisement as set forth in claim 1, wherein said advertisement processor is adapted to send information about a specific advertisement linked to said authentication number inputted from said user computer to said user computer to compulsorily run the specific advertisement therein.

3. A system for managing non-authentication-based access to at least one affiliated Web site linked with an advertisement as set forth in claim 1, wherein said access processor is adapted to process the time-limited, non-authentication-based access from said user computer in such a manner that it induces the access from said user computer to a back door site requiring no ID and password input, provided from said affiliated Web site.

4. A system for managing non-authentication-based access to at least one affiliated Web site linked with an advertisement as set forth in claim 1, wherein said access processor is adapted to process the time-limited, non-authentication-based access from said user computer in such a manner that it sends time-limited, non-authentication-based access request information containing an Internet protocol (IP) address of said user computer to said affiliated Web site so that said Web site grants the access from said user computer with the IP address.

5. A system for managing non-authentication-based access to at least one affiliated Web site linked with an advertisement as set forth in claim 1, further comprising:
an affiliated Web site list provider for providing a screen interface for affiliated Web site selection with link information regarding a plurality of affiliated Web sites to said user computer and receiving affiliated Web site selection information from said user computer.

6. A system for managing non-authentication-based access to at least one affiliated Web site linked with an advertisement as set forth in claim 1, further comprising:
an adult authentication processor for providing a screen interface for adult authentication to said user computer, receiving personal information of the user containing his/her name and resident registration number inputted from said user computer, requesting a rating server of a credit rating company to identify the user with the personal information, receiving the identification result from said rating server and performing an adult authentication process based on the received identification result, said credit rating company being an authorized credit information company.

7. A system for managing non-authentication-based access to at least one affiliated Web site linked with an advertisement as set forth in claim 1, further comprising:
a charging processor for receiving charging request information containing said authentication number for the time-limited, non-authentication-based access from said user computer, searching said authentication number database for the same authentication number as that contained in the received charging request information to determine whether the same authentication number is present in said database, authenticating said authentication number contained in the received charging request information if the same authentication number is present in said database, and charging the authenticated authentication number so that it can be reused.

8. A system for managing non-authentication-based access to at least one affiliated Web site linked with an advertisement as set forth in claim 7, further comprising:
a settlement processor for providing a screen interface for payment request associated with the authentication number charging to said user computer, and requesting a financial company's financial server to perform a settlement process based on payment information inputted from said user computer.

9. A system for managing non-authentication-based access to at least one affiliated Web site linked with an advertisement as set forth in claim 2, wherein said access processor is adapted to process the time-limited, non-authentication-based access from said user computer in such a manner that it induces the access from said user computer to a back door site requiring no ID and password input, provided from said affiliated Web site.

10. A system for managing non-authentication-based access to at least one affiliated Web site linked with an advertisement as set forth in claim 2, wherein said access processor is adapted to process the time-limited, non-authentication-based access from said user computer in such a manner that it sends time-limited, non-authentication-based access request information containing an Internet protocol (IP) address of said user computer to said affiliated Web site so that said Web site grants the access from said user computer with the IP address.

11. A system for managing non-authentication-based access to at least one affiliated Web site linked with an advertisement as set forth in claim 2, further comprising:
an affiliated Web site list provider for providing a screen interface for affiliated Web site selection with link information regarding a plurality of affiliated Web sites to said user computer and receiving affiliated Web site selection information from said user computer.

12. A system for managing non-authentication-based access to at least one affiliated Web site linked with an advertisement as set forth in claim 2, further comprising:
an adult authentication processor for providing a screen interface for adult authentication to said user computer, receiving personal information of the user containing his/her name and resident registration number inputted from said user computer, requesting a rating server of a credit rating company to identify the user with the personal information, receiving the identification result from said rating server and performing an adult authentication process based on the received identification result, said credit rating company being an authorized credit information company.

13. A system for managing non-authentication-based access to at least one affiliated Web site linked with an advertisement as set forth in claim 2, further comprising:
a charging processor for receiving charging request information containing said authentication number for the time-limited, non-authentication-based access from said user computer, searching said authentication number database for the same authentication number as that contained in the received charging request information to determine whether the same authentication number is present in said database, authenticating said authentication number contained in the received charging request information if the same authentication number is present in said database, and charging the authenticated authentication number so that it can be reused.
